(19) United States
(12) Patent Application Publication
(10) Pub. No.: US 2013/0180947 A1
(43) Pub. Date: Jul. 18, 2013

(54) ETCHING COMPOSITION AND METHOD OF MANUFACTURING A DISPLAY SUBSTRATE USING THE SAME

(71) Applicants: In-Bae KIM, Asan-si (KR); Jae-Woo JEONG, Incheon (KR); Sang-Gab KIM, Seoul (KR); Ji-Young PARK, Hwaseong-si (KR); Jong-Hyun CHOUNG, Hwaseong-si (KR); Seon-il KIM, Seoul (KR); Yong-Sung SONG, Daejeon (KR); Jong-Hyun OH, Daejeon (KR)

(72) Inventors: In-Bae KIM, Asan-si (KR); Jae-Woo JEONG, Incheon (KR); Sang-Gab KIM, Seoul (KR); Ji-Young PARK, Hwaseong-si (KR); Jong-Hyun CHOUNG, Hwaseong-si (KR); Seon-il KIM, Seoul (KR); Yong-Sung SONG, Daejeon (KR); Jong-Hyun OH, Daejeon (KR)

(73) Assignees: Soulbrain Co., Ltd., Seongnam-si (KR); Samsung Display Co., Ltd., Yongin-City (KR)

(21) Appl. No.: 13/588,825

(22) Filed: Aug. 17, 2012

(30) Foreign Application Priority Data
Jan. 18, 2012 (KR) 10-2012-0005468

(51) Int. Cl. C09K 13/06; H01B 13/00; C09K 13/00

(52) U.S. Cl. 216/13; 252/79.1; 252/79.4

(57) ABSTRACT

An etching composition that includes, based on the total weight of the etching composition, from about 0.05% to about 15% by weight of a halogen-containing compound, from about 0.1% to about 20% by weight of a nitrate compound, from about 0.1% to about 10% by weight of an acetate compound, from about 0.1% to about 10% by weight of a cyclic amine compound, from about 0% to about 50% by weight of a polyhydric alcohol, and a remainder of water.

### CROSS-REFERENCE TO RELATED APPLICATION

This application claims priority from and the benefit of Korean Patent Application No. 10-2012-0005468, filed on Jan. 18, 2012, which is hereby incorporated by reference for all purposes as if fully set forth herein.

### BACKGROUND

1. Field

Exemplary embodiments of the present invention relate to an etching composition and a method of manufacturing a display substrate using the etching composition.

2. Discussion of the Background

Generally, a display panel includes a display substrate including a thin-film transistor as a switching element for driving a pixel. The display substrate may include a plurality of metal patterns that are generally formed through a photolithography process. According to the photolithography process, a photoresist layer is formed on a film to be etched, and the photoresist layer is exposed to light and developed to form a photoresist pattern. The film is etched by an etching composition or an etching gas, using the photoresist pattern as an etch-stop layer.

When the film is a transparent conductive layer including, for example, indium tin oxide (ITO), an etching composition, such as an aqua regia-based etching composition, an iron chloride-based etching composition, or an oxalic acid-based etching composition, may be used.

However, it is difficult to maintain the composition ratio of an aqua regia-based etching composition since hydrochloric acid and nitric acid may be easily vaporized. Thus, fumes may be generated that can contaminate process conditions. Furthermore, a copper layer or a copper alloy layer, which are widely used for an electrode of a thin-film transistor in a liquid crystal display device, may be easily damaged by an aqua regia-based etching composition. An iron chloride-based etching composition has a relatively etching selectivity for side surfaces of an object film much, and may cause iron contamination. Furthermore, an oxalic acid-based etching composition may readily generate a residue and oxalate crystals, on an inner surface of an etching apparatus, after an etching process is performed.

### SUMMARY OF THE INVENTION

Exemplary embodiments of the present invention provide an etching composition capable of etching a transparent conductive layer, while preventing and/or reducing damage to a metal layer including copper or a copper alloy.

Exemplary embodiments of the present invention further provide a method of manufacturing a display substrate using the etching composition.

According to an exemplary embodiment of the present invention, an etching composition includes about 0.05% to about 15% by weight of a halogen-containing compound, about 0.1% to about 20% by weight of a nitrate compound, about 0.1% to about 10% by weight of an acetate compound, about 0.1% to about 10% by weight of a cyclic amine compound, about 0% to about 50% by weight of a polyhydric alcohol, and a remainder of water.

In an exemplary embodiment, an amount of the halogen-containing compound is about 0.05% to about 10% by weight, an amount of the nitrate compound is about 5% to about 15% by weight, an amount of the acetate compound is about 0.1% to about 10% by weight, an amount of the cyclic amine compound is about 0.1% to about 5% by weight, and an amount of the polyhydric alcohol is about 0% to about 30% by weight.

According to an exemplary embodiment of the present invention, a method of manufacturing a display substrate is provided. According to the method, a switching element, including a gate electrode, a source electrode, and a drain electrode, is formed on a substrate. A transparent conductive layer is formed on the substrate having the switching elements. The transparent conductive layer is patterned by an etching composition to form a pixel electrode that contacts the drain electrode. The etching composition includes about 0.05% to about 15% by weight of a halogen-containing compound, about 0.1% to about 20% by weight of a nitrate compound, about 0.1% to about 10% by weight of an acetate compound, about 0.1% to about 10% by weight of a cyclic amine compound, about 0% to about 50% by weight of a polyhydric alcohol, and a remainder of water.

According to exemplary embodiments of the present invention, problems, which may be caused by conventional etching composition, such as crystallization at a low temperature, excessively etching of side surfaces, or the generation of skew, may be prevented or reduced. Furthermore, metal layers other than the transparent conductive layer, such as a copper layer or a copper alloy layer, may be protected from damage or corrosion during etching of the transparent conductive layer.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a plan view illustrating a display substrate manufactured according to an exemplary embodiment of the present invention.

FIG. 2 is a cross-sectional view taken along a line I-I′ and a line II-II′ in FIG. 1.

FIG. 3, FIG. 4, and FIG. 5 are cross-sectional views illustrating a method of manufacturing the display substrate shown in FIG. 1.

FIGS. 6A, 6B, and 6C are scanning electron microscope (SEM) micrographs showing profiles of patterns etched by the etching compositions of Examples 1 to 3.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

It will be understood that for the purposes of this disclosure, “at least one selected from the group consisting of X, Y, and Z” can be construed as X only, Y only, Z only, or any combination of two or more items X, Y, and Z (e.g., XYZ, XYY, YZ, ZZ).

An etching composition, according to an exemplary embodiment of the present invention, includes about 0.05% to about 15% by weight of a halogen-containing compound, about 0.1% to about 20% by weight of a nitrate compound, about 0.1% to about 10% by weight of an acetate compound, about 0.1% to about 10% by weight of a cyclic amine compound, about 0% to about 50% by weight of a polyhydric alcohol, and a remainder of water.

The etching composition is used for etching a transparent conductive layer, which may include an indium oxide layer. Particularly, the indium oxide layer may include indium zinc oxide (IZO), indium tin oxide (ITO), and the like. The indium oxide layer may have crystalline phase or amorphous phase. Furthermore, the transparent conductive layer may include zinc oxide, and the like.

The halogen-containing compound may selectively etch the transparent conductive layer. Any compound capable of generating halogen ions or polyatomic halogen ions in a solution may be used as the halogen-containing compound. For example, the halogen-containing compound may be represented the following Chemical Formula 1.

AXₙ <Chemical Formula 1>

In Chemical Formula 1, A represents a cation, X represents a halogen atom, n represents a natural number from 1 to 3 that is same as the oxidation number of A. For example, A may represent a hydrogen ion, an ammonium ion, an alkyl metal ion, an iron ion, an aluminum ion, or the like, and X may represent a fluorine ion, a chlorine ion, an iodine ion, a bromine ion, or the like.

Examples of the halogen-containing compound may include a hydrogen halide, an ammonium halide, an iron halide, and an alkali halide. More particularly, examples of the halogen-containing compound may include hydrochloric acid (HCl ), aluminum chloride (AlCl₃), ammonium fluoride (NH₄F), potassium chloride (KCl), potassium iodide (KI), ammonium chloride (NH₄Cl), and the like. These compounds may be used alone or in any combination.

When an amount of the halogen-containing compound is excessively large, metal layers other than the transparent conductive layer, such as a copper layer or a copper alloy layer, may be damaged. When an amount of the halogen-containing compound is excessively small, an etching ratio to the transparent conductive layer may be reduced. Thus, an amount of the halogen-containing compound may be about 0.05% to about 15% by weight, based on the total weight of the etching composition. In some embodiments, an amount of the halogen-containing compound may be about 0.05% to about 10% by weight.

The etching composition, according to an exemplary embodiment of the present invention, may include an amount of the halogen-containing compound sufficient to stably control an etching ratio with respect to the transparent conductive layer. For example, when an amount of the halogen-containing compound is increased within the above range, an etching ratio to the transparent conductive layer may be increased, without changing a taper angle and a skew length of an obtained pattern. Furthermore, when an amount of the halogen-containing compound is reduced within the above range, an etching ratio to the transparent conductive layer may be reduced, without changing a taper angle and a skew length of an obtained pattern.

The nitrate compound may also etch the transparent conductive layer. Any compound that is capable of generating a nitrate compound ion (NO₃⁻) in a solution may be used as the nitrate compound. Examples of the nitrate compound may include ammonium nitrate (NH₄NO₃), potassium nitrate (KNO₃), nitric acid (HNO₃), copper nitrate (CuNO₃), sodium nitrate (NaNO₃), and the like. These compounds may be used alone or in any combination. When an amount of the nitrate compound is excessively large, metal layers other than the transparent conductive layer, such as a copper layer or a copper alloy layer, may be damaged. When an amount of the nitrate compound is excessively small, an etching ratio to the transparent conductive layer may be reduced. Thus, an amount of the nitrate compound may be about 0.1% to about 20% by weight, based on the total weight of the etching composition. According to some embodiments, amount of the nitrate compound may be about 5% to about 15% by weight.

The acetate compound may increase the wettability of the etching composition in order to inhibit a skew. For example, the acetate compound may be represented by the following Chemical Formula 2.

B(CH₃COO)ₙ <Chemical Formula 2>

In Chemical Formula 2, B represents a cation, and n represents a natural number from 1 to 3, which is same as an oxidation number of B. For example, A may represent a hydrogen ion, an ammonium ion, an alkyl metal ion, an iron ion, an aluminum ion, and the like.

Examples of the acetate compound may include acetic acid (CH₃COOH), potassium acetate (CH₃COOK), ammonium acetate(CH₃COONH₄), sodium acetate (CH₃COOH), magnesium acetate (Mg(CH₃COO)₂), manganese acetate (Mn(CH₃COO)₂), zinc acetate (Zn(CH₃COO)₂), and the like. These compounds may be used alone or in any combination. According to some embodiments, the amount of the acetate compound maybe about 0.1% to about 10% by weight, based on the total weight of the etching composition.

The cyclic amine compound may prevent or reduce damage to a copper layer or a copper alloy layer. The cyclic amine compound may include a water-soluble hetero cyclic amine compound. Examples of the cyclic amine compound may include aminotetrazole, imidazole, indole, purine, pyrazole, pyridine, pyrimidine, pyrrole, pyrrolidine, pyrroline, and the like. These compounds may be used alone or in any combination.

Aminotetrazole in particular may be used as the cyclic amine compound, and examples of the aminotetrazole may include aminotetrazole, 5-amino-1-phenyltetrazole, 5-amino-1-(1-naphthyl)tetrazole, 1-methyl-5-aminotetrazole, 1,5-diaminotetrazole, and the like. These compounds may be used alone or in any combination.

When an amount of the cyclic amine compound is excessively large, an etching ratio to the transparent conductive layer may be reduced. When an amount of the cyclic amine compound is excessively small, metal layers other than the transparent conductive layer, such as a copper layer or a copper alloy layer, may be damaged. Thus, an amount of the cyclic amine compound may generally be about 0.1% to about 10% by weight, based on the total weight of the etching composition. According to some embodiments, the amount of the cyclic amine compound may be about 0.1% to about 5% by weight.

The polyhydric alcohol may reduce a vaporizing ratio of the etching composition, so that a composition ratio of the etching composition may be stably maintained. Thus, fumes may be reduced. When an amount of the polyhydric alcohol is excessively large, an etching ratio to the transparent conductive layer may be reduced. Thus, an amount of the polyhydric alcohol may generally be no more than about 50% by weight, based on the total weight of the etching composition. According to some embodiments, the amount of the polyhydric alcohol may be about 0% to about 30% by weight.

Examples of the polyhydric alcohol may include ethylene glycol, tetraethylene glycol, propylene glycol, butylene glycol, polyethylene glycol, polypropylene glycol, polytetramethylene glycol, and the like. These compounds may be used alone or in any combination.

The etching composition may further include water. The water may be added to the halogen-containing compound, the nitrate compound, the acetate compound, the cyclic amine compound, and/or the polyhydric alcohol.

Water used in the etching composition is not limited to any specific type. The water used in the etching composition may be deionized water. The water used in the etching composition may be deionized water having a specific resistance of about 18MΩ/cm. An amount of water used in the etching composition is determined based on amounts of the halogen-containing compound, the nitrate compound, the acetate compound, the cyclic amine compound, and/or the polyhydric alcohol. For example, the amount of water may be referred to as a remainder of the etching composition excluding the amounts of the halogen-containing compound, the nitrate compound, the acetate compound, the cyclic amine compound, and the polyhydric alcohol. For example, the etching composition may include about 20% to about 90% by weight of water, based on the total weight of the etching composition.

The etching composition, according to an exemplary embodiment of the present invention, does not include a sulfate compound capable of generating sulfate ions (SO₄²⁻) in a solution. Sulfate ions may damage metal layers other than the transparent conductive layer and may damage a processing apparatus. Furthermore, sulfate ions may be easily combined with copper, thereby damaging a copper layer or a copper alloy layer. Examples of sulfate compounds include ammonium sulfate, sodium sulfate, potassium sulfate, ammonium pursulfate, sodium pursulfate, potassium pursulfate, and the like.

The etching composition, according to an exemplary embodiment of the present invention, may prevent or reduce problems caused by conventional etching compositions, such as crystallization at a low temperature, excessively etching side surfaces, or the generation of skew. Furthermore, metal layers other than the transparent conductive layer, such as a copper layer or a copper alloy layer, may be prevented from being damaged or corroded while etching the transparent conductive layer.

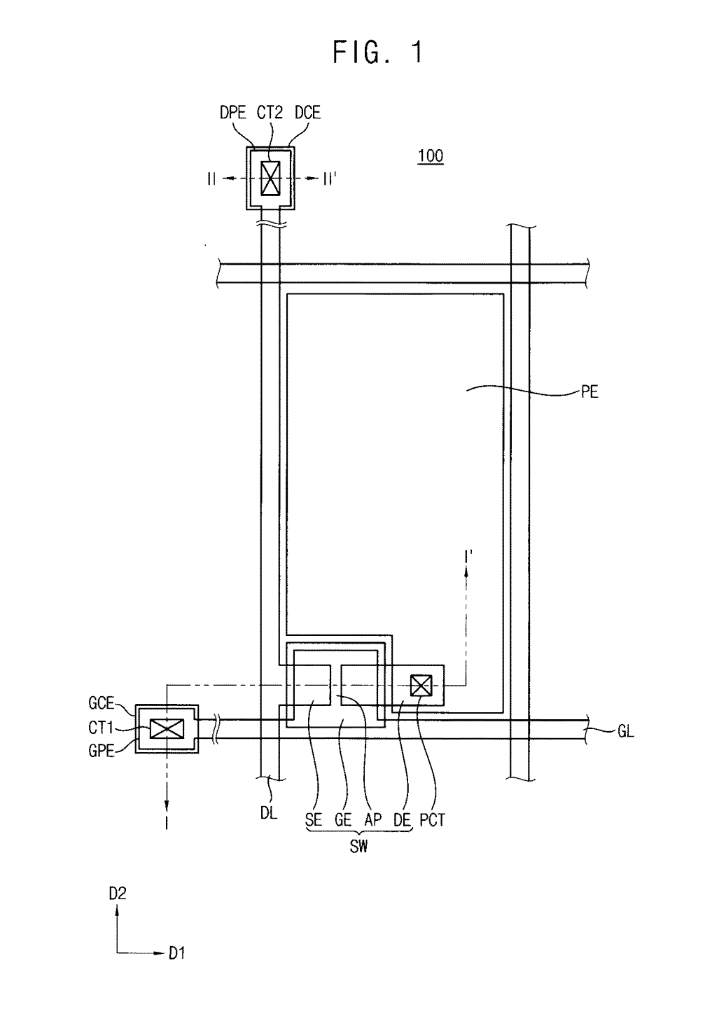

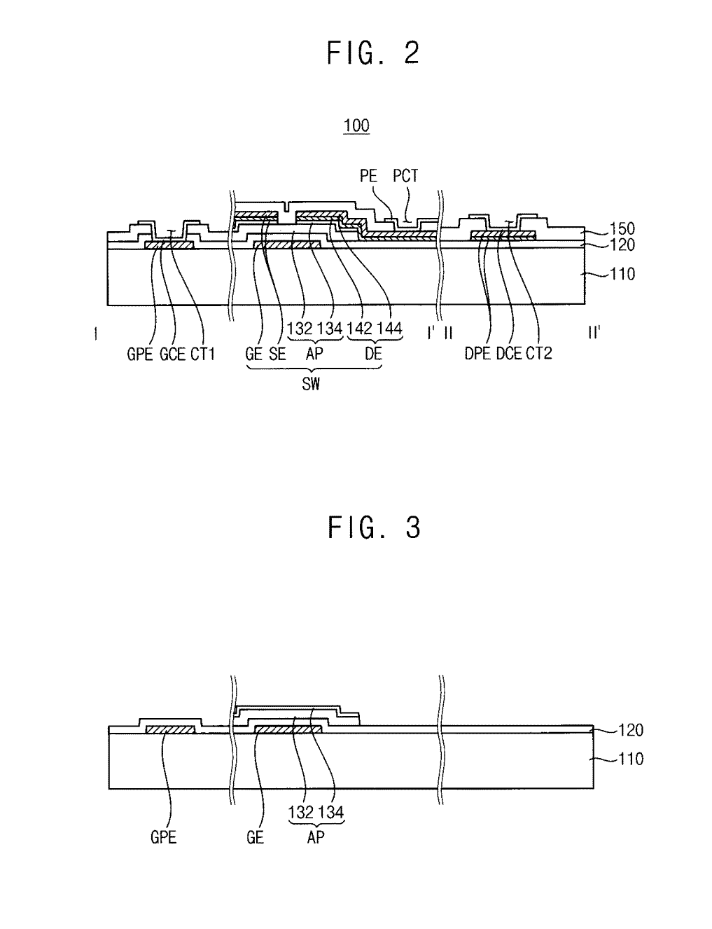

Hereinafter, a method of manufacturing a display substrate, according to an exemplary embodiment of the present invention, will be explained in detail with reference to accompanying drawings. FIG. 1 is a plan view illustrating a display substrate manufactured according to an exemplary embodiment of the present invention. FIG. 2 is a cross-sectional view taken along a line I-I′ and a line II-II′ in FIG. 1.

Referring to FIG. 1 and FIG. 2, a display substrate 100 includes a gate line GL, a data line DL, a switching element SW, and a pixel electrode PE. The display substrate 100 further includes a gate pad electrode GPE connected to an end of the gate line GL and provided with a gate signal from a gate driver, and a data pad electrode DPE connected to an end of the date line DL and provided with a data signal from a data driver.

The gate line GL extends along a first direction D1 and has a rectangular shape extending lengthwise in the first direction D1. The data line DL extends along a second direction D2 that is substantially orthogonal to the first direction D1 and has a straight linear shape that extends lengthwise in the second direction D2.

The switching element SW is electrically connected to the gate line GL and the data line DL. The switching element SW includes a gate electrode GE, an active pattern AP, a source electrode SE, and a drain electrode DE. The drain electrode DE directly contacts the pixel electrode PE, so that the switching element SW is electrically connected to the pixel electrode PE.

The gate line GL, the gate electrode GE, and the gate pad electrode GPE may be formed from a single gate metal layer. The data line DL, the source electrode SE, the drain electrode DE, and the data pad electrode DPE may be formed from a single data metal layer.

The gate line GL, the gate electrode GE, and the gate pad electrode GPE may be formed from a single metal layer, a single metal alloy layer, or a multiple-layered metal layer having layers of different metallic materials. In the exemplary embodiment, the gate line GL, the gate electrode GE, and the gate pad electrode GPE are formed from a single copper layer.

The data line DL, the source electrode SE, the drain electrode DE, and the data pad electrode DPE may be formed from a single metal layer, a single metal alloy layer, or a multiple-layered metal layer having layers of different metallic materials. In the exemplary embodiment, each of the data line DL, the source electrode SE, the drain electrode DE, and the data pad electrode DPE include a first metal layer 142 and a second metal layer 144. The first metal layer 142 may be a titanium layer, and the second metal layer 144 may be a copper layer.

A first insulating layer 120 is formed between the gate electrode GE and the active pattern AP. The first insulating layer 120 may insulate the gate line GL from the data line DL. A second insulating layer 150 is formed on the source electrode SE, the drain electrode DE, and the data pad electrode DPE. A portion of the gate pad electrode GPE is exposed through a first pad hole CT1 formed through the first and second insulating layers 120 and 150. A portion of the data pad electrode DPE is exposed through a second pad hole CT2 formed through the second insulating layer 150. In addition, the second insulating layer 150 includes a contact hole PCT exposing a portion of the drain electrode DE.

The pixel electrode PE is formed on the second insulating layer 150 and makes contact with the drain electrode DE through the contact hole PCT. A gate contact electrode GCE is formed on the gate pad electrode GPE. The gate contact electrode GCE contacts the gate pad electrode GPE through the first pad hole CT1. A data contact electrode DCE is formed on the data pad electrode DPE. The data contact electrode DCE contacts the data pad electrode DPE through the second pad hole CT2. The data pad electrode DPE is directly formed on the first insulating layer 120.

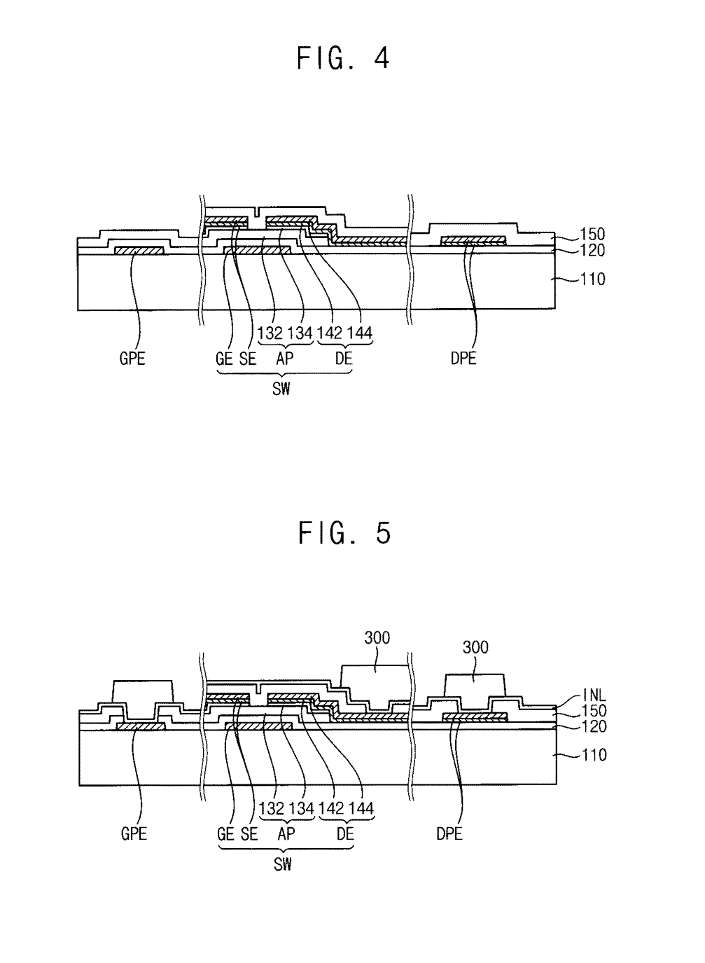

FIG. 3, FIG. 4, and FIG. 5 are cross-sectional views illustrating a method of manufacturing the display substrate shown in FIG. 1, according to an exemplary embodiment of the present disclosure. Referring to FIG. 3, the gate electrode GE and the gate pad electrode GPE are formed using a first mask (not shown). The first insulating layer 120 is formed on the base substrate 110 on which the gate electrode GE and the gate pad electrode GPE are formed. A semiconductor layer 132 and an ohmic contact layer 134 are formed on the first insulating layer 120 using a second mask (not shown).

Referring to 4, the source electrode SE, the drain electrode DE, and the data pad electrode DPE are formed using a third mask (not shown) on the base substrate 110, on which the active pattern AP is formed. In particular, the first and second metal layers 142 and 144 are sequentially formed on the base substrate 110 on which the active pattern AP is formed, and a first photo pattern is formed on the second metal layer 144 using the third mask. The first and second metal layer 142 and 144 are etched using the first photo pattern as an etch-stop layer. Thereafter, the second insulating layer 150 is formed on the base substrate 110, on which the source electrode SE, the drain electrode DE and the data pad electrode DPE are formed.

Referring to FIG. 5, a second photo pattern is formed on the second insulating layer 150 using a fourth mask (not shown). The first and second pad holes CT1 and CT2 and the contact hole PCT are then formed using the second photo pattern.

Thereafter, an indium oxide layer INL is formed on the base substrate 110 on which the contact hole PCT (see FIG. 2) is formed. A third photo pattern 300 is then formed using a fifth mask (not shown). The third photo pattern 300 is formed in a pixel region and regions in which the gate pad electrode GPE and the data pad electrode DPE are formed. The indium oxide layer INL is patterned using the third photo pattern 300 as an etch-stop layer, to form the pixel electrode PE.

The indium oxide layer INL may include indium zinc oxide (IZO), indium tin oxide (ITO), and the like. The indium oxide layer INL may have a crystalline phase or an amorphous phase. When the indium oxide layer INL has an amorphous phase, the indium oxide layer INL may be heated after the indium oxide layer INL is etched. Accordingly, the indium oxide layer INL may be crystallized.

The indium oxide layer INL may be etched by the above-described etching composition. Since the etching composition is described above, a description thereof will not be repeated.

The etching composition may prevent or reduce damage to metal layers, such as the second metal layer 144, the data pad electrode DPE, and the gate pad electrode GPE, during the etching the indium oxide layer INL.

In the exemplary embodiment, the second mask for forming the active pattern AP is different from the third mask for forming the source electrode SE, the drain electrode DE, and the data pad electrode DPE. In another exemplary embodiment, a single mask may be used for forming the active pattern AP, the source electrode SE, the drain electrode DE, and the data pad electrode DPE.

In the exemplary embodiment, each of the data line DL, the source electrode SE, the drain electrode DE, and the data pad electrode DPE include the first and second metal layers 142 and 144. The first metal layer 142 includes a titanium layer, and the second metal layer 144 includes a copper layer. In another exemplary embodiment, each of the gate line GL, the gate electrode GE, and the gate pad electrode GPE may have a double-layered structure including a copper layer and a titanium layer. Furthermore, the first metal layer 142 may include a metal layer other than the titanium layer, such as an aluminum layer, a molybdenum layer, or an alloy layer thereof.

According to the method of manufacturing a display substrate, according to an exemplary embodiment of the present invention, problems that may be caused by conventional etching composition, such as crystallization at a low temperature, excessively etching a side surface, or generating a skew, may be prevented or reduced. Furthermore, metal layers other than the transparent conductive layer, such as a copper layer or a copper alloy layer, may be prevented from being damaged or corroded during the etching of the transparent conductive layer.

Hereinafter, exemplary embodiments of the present invention will be explained in detail, with reference to experimental results based on particular Examples and Comparative Examples.

### EXAMPLE 1

About 1% by weight of ammonium chloride as a halogen-containing compound, about 12% by weight of nitric acid as a nitrate compound, about 1% by weight of potassium acetate as an acetate compound, about 1% by weight of aminotetrazole as a cyclic amine compound, about 10% by weight of ethylene glycol as a polyhydric alcohol, and a remainder of water were mixed to prepare an etching composition.

### EXAMPLE 2

About 5% by weight of ammonium chloride, about 12% by weight of nitric acid, about 1% by weight of potassium acetate, about 1% by weight of aminotetrazole, about 10% by weight of ethylene glycol, and a remainder of water were mixed to prepare an etching composition.

### EXAMPLE 3

About 10% by weight of ammonium chloride, about 12% by weight of nitric acid, about 1% by weight of potassium acetate, about 1% by weight of aminotetrazole, about 10% by weight of ethylene glycol, and a remainder of water were mixed to prepare an etching composition.

### COMPARATIVE EXAMPLE 1

About 20% by weight of ammonium chloride, about 12% by weight of nitric acid, about 1% by weight of potassium acetate, about 1% by weight of aminotetrazole, about 10% by weight of ethylene glycol, and a remainder of water were mixed to prepare an etching composition.

### COMPARATIVE EXAMPLE 2

About 5% by weight of ammonium chloride, about 30% by weight of nitric acid, about 1% by weight of potassium acetate, about 1% by weight of aminotetrazole, about 10% by weight of ethylene glycol, and a remainder of water were mixed to prepare an etching composition.

### COMPARATIVE EXAMPLE 3

About 10% by weight of ammonium chloride, about 12% by weight of nitric acid, about 20% by weight of potassium acetate, about 1% by weight of aminotetrazole, about 10% by weight of ethylene glycol, and a remainder of water were mixed to prepare an etching composition.

### COMPARATIVE EXAMPLE 4

About 10% by weight of ammonium chloride, about 12% by weight of nitric acid, about 1% by weight of potassium acetate, about 15% by weight of aminotetrazole, about 10% by weight of ethylene glycol, and a remainder of water were mixed to prepare an etching composition.

### COMPARATIVE EXAMPLE 5

About 1% by weight of ammonium chloride, about 12% by weight of nitric acid, about 1% by weight of potassium acetate, about 10% by weight of ethylene glycol, and a remainder of water were mixed to prepare an etching composition.

### COMPARATIVE EXAMPLE 6

5% aqueous solution of oxalic acid, which is not known to be particularly damaging to a copper layer, was prepared as an etching composition

### COMPARATIVE EXAMPLE 7

About 1% by weight of ammonium chloride, about 9% by weight of nitric acid, about 0.1% by weight of sulfuric acid, about 4% by weight of aminotetrazole, about 15% by weight of ethylene glycol, and a remainder of water were mixed to prepare an etching composition.

### Experiment for Evaluating Etching Characteristics and Damage to Copper

An indium tin oxide layer having a thickness of about 450 Å was formed on a glass substrate having a size of about 100 nm×100 nm, and a photoresist pattern was formed on the indium tin oxide layer. Each of the etching compositions of Examples 1 to 3 and Comparative Examples 1 to 6 was sprayed to etch the indium tin oxide layer. A temperature of each of the etching compositions was maintained to be about 46° C., and an etching time was about 130 seconds.

In order to evaluate the damage to copper, a glass substrate having a copper layer was dipped in each of the etching compositions of Examples 1 to 3 and Comparative Examples 1 to 7 for about 2 hours, and a copper ion concentration in each of the etching compositions was measured using inductively coupled plasma mass spectroscopy (ICP-MS). The temperature of each of the etching compositions was maintained to be about 46° C.

Thus obtained results are shown in the following Table 1.

TABLE 1

| | Etching | | |
|---|---|---|---|
| | ratio | Taper angle | Copper ion |
| | (Å/sec) | (°) | concentration (ppb) |
| Example 1 | 8.1 | 50 | 113 |
| Example 2 | 14.3 | 50 | 127 |
| Example 3 | 21.7 | 50 | 121 |
| Comparative Example 1 | 42.1 | 109 | 201 |
| Comparative Example 2 | 21.8 | 118 | 308 |
| Comparative Example 3 | — | — | 165 |
| Comparative Example 4 | — | — | 47 |
| Comparative Example 5 | 8.2 | 48 | 964 |
| Comparative Example 6 | 10.6 | 40 | 109 |
| Comparative Example 7 | — | — | 915 |

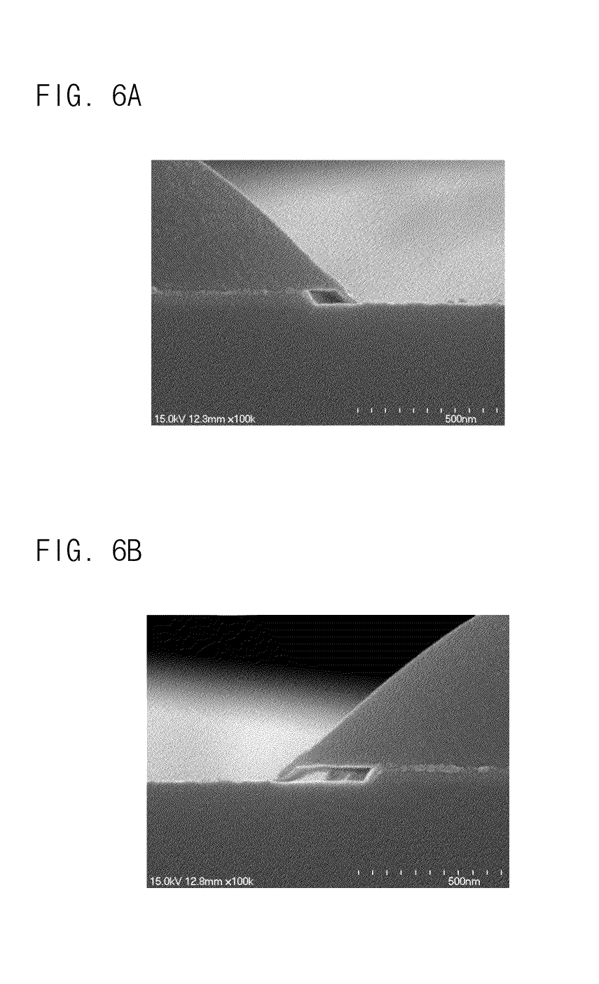

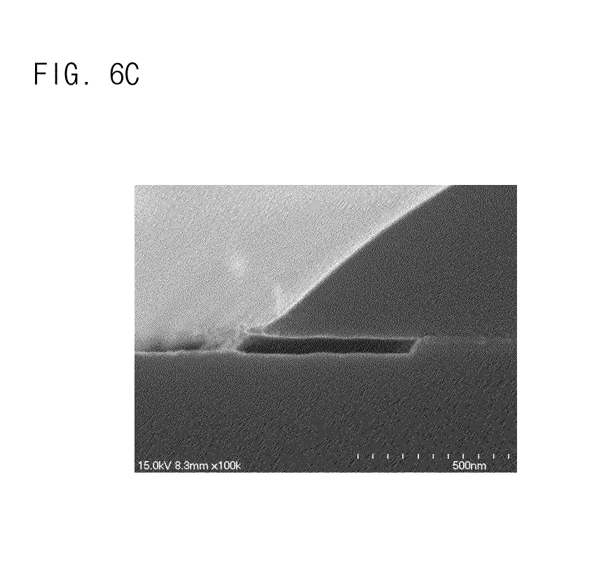

FIGS. 6A, 6B, and 6C are scanning electron microscope (SEM) micrographs showing profiles of patterns etched by the etching compositions of Examples 1 to 3.

Referring to Table 1, the copper ion concentrations measured after the copper layer was dipped in the etching compositions of Examples 1 to 3 were relatively small and were close to the copper ion concentration measured after the copper layer was dipped in an oxalic acid. However, the copper ion concentrations measured after the copper layer was dipped in the etching compositions of Comparative Examples 1, 2, 3, and 5 and Comparative Example 7, which included sulfuric acid, were relatively large. Thus, it can be noted that etching compositions of Comparative Examples 1, 2, 3, 5, and 7 may increase damage to a copper layer. Furthermore, the pattern obtained by using the etching compositions of Comparative Examples 1 and 2 had an inverse-tapered shape, which may reduce the stability of a pattern. Furthermore, the etching compositions of Comparative Examples 1 and 2 did not complete etching even if the etching compositions of Comparative Examples 1 and 2 included same materials as the etching compositions of Examples 1 to 3. Thus, etching characteristics of the etching compositions may change depending on an amount of each component in the etching compositions.

Furthermore, referring to Table 1 and FIGS. 6A to 6C, when an amount of the halogen-containing compound was changed, an etching ratio was changed, without changing a taper angle. Thus, the etching compositions according to the Examples of the present invention may be easily employed for manufacturing processes.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An etching composition comprising, based on the total weight of the etching composition:
from about 0.05% to about 15% by weight of a halogen-containing compound;
from about 0.1% to about 20% by weight of a nitrate compound;
from about 0.1% to about 10% by weight of an acetate compound;
from about 0.1% to about 10% by weight of a cyclic amine compound;
from about 0% to about 50% by weight of a polyhydric alcohol; and
a remainder of water.

2. The etching composition of claim 1, wherein the halogen-containing compound comprises at least one selected from the group consisting of hydrochloric acid (HCl), aluminum chloride (AlCl₃), ammonium fluoride (NH₄F), potassium chloride (KCl), potassium iodide (KI), and ammonium chloride (NH₄Cl).

3. The etching composition of claim 1, wherein the nitrate compound comprises at least one selected from the group consisting of ammonium nitrate (NH₄NO₃), potassium nitrate (KNO₃), nitric acid (HNO₃), copper nitrate (CuNO₃), and sodium nitrate (NaNO₃).

4. The etching composition of claim 1, wherein the acetate compound comprises at least one selected from the group consisting of acetic acid (CH₃COOH), potassium acetate (CH₃COOK), ammonium acetate(CH₃COONH₄), sodium acetate (CH₃COOH), magnesium acetate (Mg(CH₃COO)₂), manganese acetate (Mn(CH₃COO)₂), and zinc acetate (Zn(CH₃COO)₂).

5. The etching composition of claim 1, wherein the cyclic amine compound comprises at least one selected from the group consisting of aminotetrazole, imidazole, indole, purine, pyrazole, pyridine, pyrimidine, pyrrole, pyrrolidine, and pyrroline.

6. The etching composition of claim 1, wherein the polyhydric alcohol comprises at least one selected from the group consisting of ethylene glycol, tetraethylene glycol, propylene glycol, butylene glycol, polyethylene glycol, polypropylene glycol, and polytetramethylene glycol.

7. The etching composition of claim 1, wherein:
the halogen-containing compound comprises ammonium chloride;
the nitrate compound comprises nitric acid;
the acetate compound comprises potassium acetate;
the cyclic amine compound comprises aminotetrazole; and
the polyhydric alcohol comprises ethylene glycol.

8. The etching composition of claim 1, wherein based on the total weight of the etching composition:
the amount of the halogen-containing compound is from about 0.05% to about 10% by weight;
the amount of the nitrate compound is from about 5% to about 15% by weight;
the amount of the acetate compound is from about 0.1% to about 10% by weight;
the amount of the cyclic amine compound is from about 0.1% to about 5% by weight; and
the amount of the polyhydric alcohol is from about 0% to about 30% by weight.

9. A method of manufacturing a display substrate, the method comprising:
forming a switching element on a substrate, the switching element comprising an output electrode;
forming a transparent conductive layer on the substrate having the switching element; and
pattering the transparent conductive layer using an etching composition to form a pixel electrode that contacts the output electrode,
wherein the etching composition comprises, based on the total weight of the etching composition:
from about 0.05% to about 15% by weight of a halogen-containing compound;
from about 0.1% to about 20% by weight of a nitrate compound;
from about 0.1% to about 10% by weight of an acetate compound;
from about 0.1% to about 10% by weight of a cyclic amine compound;
from about 0% to about 50% by weight of a polyhydric alcohol; and
a remainder of water.

10. The method of claim 9, wherein the transparent conductive layer comprises indium oxide.

11. The method of claim 10, wherein the switching element further comprises an input electrode and a control electrode, and at least one of the control electrode, the input electrode, and the output electrode comprises a copper layer or a copper alloy layer.

12. The method of claim 10, wherein the switching element further comprises an input electrode and a control electrode, and at least one of the control electrode, the input electrode, and the output electrode comprises a titanium layer and a copper layer disposed on the titanium layer.

13. The method of claim 10, wherein the halogen-containing compound comprises at least one selected from the group consisting of hydrochloric acid (HCl), aluminum chloride (AlCl₃), ammonium fluoride (NH₄F), potassium chloride (KCl), potassium iodide (KI), and ammonium chloride (NH₄Cl).

14. The method of claim 10, wherein the nitrate compound comprises at least one selected from the group consisting of ammonium nitrate (NH₄NO₃), potassium nitrate (KNO₃), nitric acid (HNO₃), copper nitrate (CuNO₃), and sodium nitrate (NaNO₃).

15. The method of claim 10, wherein the acetate compound comprises at least one selected from the group consisting of acetic acid (CH₃COOH), potassium acetate (CH₃COOK), ammonium acetate(CH₃COONH₄), sodium acetate (CH₃COOH), magnesium acetate (Mg(CH₃COO)₂), manganese acetate (Mn(CH₃COO)₂), and zinc acetate (Zn(CH₃COO)₂).

16. The method of claim 10, wherein the cyclic amine compound comprises at least one selected from the group consisting of aminotetrazole, imidazole, indole, purine, pyrazole, pyridine, pyrimidine, pyrrole, pyrrolidine, and pyrroline.

17. The method of claim 10, wherein the polyhydric alcohol comprises at least one selected from the group consisting of ethylene glycol, tetraethylene glycol, propylene glycol, butylene glycol, polyethylene glycol, polypropylene glycol, and polytetramethylene glycol.

18. The method of claim 10, wherein:
the halogen-containing compound comprises ammonium chloride;
the nitrate compound comprises nitric acid;
the acetate compound comprises potassium acetate;
the cyclic amine compound comprises aminotetrazole; and
the polyhydric alcohol comprises ethylene glycol.

19. The method of claim 10, wherein the display substrate further comprises:
a gate pad electrode formed from the same layer of material as the control electrode;
a data pad electrode formed from the same layer of material as the input electrode and the output electrode;
a gate contact electrode disposed in contact with the gate pad electrode and formed from the same layer of material as the pixel electrode; and
a data contact electrode disposed in contact with the data pad electrode and formed from the same layer of material as the pixel electrode.

20. The method of claim 9, wherein based on the total weight of the etching composition:
the amount of the halogen-containing compound is from about 0.05% to about 10% by weight;
the amount of the nitrate compound is from about 5% to about 15% by weight;
the amount of the acetate compound is from about 0.1% to about 10% by weight;
the amount of the cyclic amine compound is from about 0.1% to about 5% by weight; and
the amount of the polyhydric alcohol is from about 0% to about 30% by weight
